(19) United States
(12) Patent Application Publication
(10) Pub. No.: US 2009/0275699 A1
(43) Pub. Date: Nov. 5, 2009

(54) Starch containing formaldehyde-free thermoset binders for fiber products

(76) Inventors: Mingfu Zhang, Highlands Ranch, CO (US); Kiarash Alavi Shooshtari, Littleton, CO (US); Jawed Asrar, Greenwood Village, CO (US); Uranchimeg Lester, Littleton, CO (US); Mary Margaret Georgene Bauer, Littleton, CO (US)

Correspondence Address: JOHNS MANVILLE, 10100 WEST UTE AVENUE, PO BOX 625005, LITTLETON, CO, 80162-5005, US

(21) Appl. No.: 12/151,203

(22) Filed: May 5, 2008

(51) Int. Cl. C08G 63/91; C08F 20/06

(52) U.S. Cl. 525/54.26; 525/54.24

(57) ABSTRACT

Binder compositions are described that include a carboxyl-containing polymer, a cross-linking agent, and a starch compound having a molecular weight greater than about 10,000 g/mol. In addition, fiber products are described that include mineral or polymeric fibers and a binder prepared from an aqueous composition that includes a carboxyl-containing polymer, a cross-linking agent, and a starch having a molecular weight greater than 10,000 g/mol.

### BACKGROUND OF THE INVENTION

Starches have many industrial uses in various areas, such as textile, paper, adhesives, and mining. Native starches have some drawbacks, however, such as low solubility in cold water, low solution stability due to gelation or precipitation, and high solution viscosity. To overcome these drawbacks, various modification techniques have been developed. For example, degradation of native starches via acid treatment and pyrolysis forms dextrins, which have higher solubility in cold water. Substitution reactions, such as esterification and etherification of native starches can increases their stability in aqueous solutions.

In the fiberglass industry, starches have been used as sizing ingredients for continuous glass fibers to prevent abrasion, add strength, and promote efficient weaving. These uses take advantage of the starches' good film-forming properties, high film strength, and low migration. Starches may also be used as binders in fiberglass. For example, starch binder compositions containing low molecular weight modified starches have been developed for making fiberglass mats. Starches have also been used in binders for woven glass textiles and FESCO boards, among other applications.

Starch containing binder compositions can be an alternative to conventional phenol/formaldehyde binders for fiberglass applications. Phenol/formaldehyde binders release significant amounts of formaldehyde when cured, resulting in formaldehyde emissions that can have an adverse environment impact. Replacing these polluting binders with formaldehyde-free thermoset binder compositions has been challenging, however, because substitute compositions have substantially higher costs. Inexpensive starches have been used to lower materials costs in these formaldehyde-free binders.

The starch containing binders use low molecular weight starches as a low cost extender to reduce the quantities of more expensive binder materials needed in the formulation while maintaining acceptable thermoset binder performance. Low molecular weight modified starches are particularly popular in these applications because they are soluble in cold water and compatible with many synthetic binders, in addition to being low cost.

Unfortunately, many formaldehyde-free, low molecular weight starch containing binders age poorly in hot and humid conditions. When these binders are used in insulation and roofing materials in hot humid climates (for example the Southeastern United States during summer) they often prematurely deteriorate and require more frequent replacement than materials made with conventional, formaldehyde generating binders. Thus, there is still an need for formaldehyde-free starch containing binder compositions that have comparable or improved aging properties to conventional formaldehyde generating binders for fiber products.

### BRIEF SUMMARY OF THE INVENTION

Starch containing, formaldehyde-free thermoset binders are described that are suitable for fiber products used in hot and humid environments. The binders are made from an aqueous composition of carboxyl-containing polymers, cross-linking agents, and starches with moderate to high molecular weights of greater than 10,000 g/mol. It has been discovered that these inexpensive starches not only reduce the need for more costly binder components, they also enhance the binder's ability to withstand aging in hostile climates.

This discovery contradicts earlier beliefs that starches have a negative impact on the moisture resistance of a fiber product. While not wishing to be bound by any particular scientific theory, it is believed the starches described are not merely extenders to reduce the binder cost, but undergo substantial chemical reaction with the other binder components to enhance the bulk properties of the binder. The starch containing binders described produce products having reduced cost and increased lifetime compared with conventional formaldehyde-free binders and low molecular weight starch containing binders.

Embodiments of the invention include binder compositions that include a carboxyl-containing polymer, a cross-linking agent, and a starch with a molecular weight greater than 10,000 g/mol. The carboxyl-containing polymer may include a polyacrylic acid, the cross-linking agent may include an amino alcohol, and the starch may include cationic starch.

Embodiments of the invention may also include fiber products that include mineral or polymeric fibers and a binder. The binder may be prepared from an aqueous composition that includes a carboxyl-containing polymer, a cross-linking agent, and a starch with a molecular weight greater than 10,000 g/mol.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 shows a bar graph of experimental results for a handsheet evaluation of various compositions of a polyacrylic binder and starches;

FIG. 2 shows another bar graph of experimental results from dogbone tensile tests of various compositions of polyacrylic binders and starches; and

FIG. 3 shows a further bar graph of experimental results from dogbone tensile tests of compositions of polystyrene maleamic acid binders and starches.

### DETAILED DESCRIPTION OF THE INVENTION

Binder compositions are described that may include carboxyl-containing polymers and moderate to high molecular weight starches (e.g., starches with molecular weights of about 10,000 g/mol or more). Embodiments include adding the starch to a conventional, formaldehyde-free carboxyl-containing polymer binder that includes the acid polymer and a cross-linking agent. A portion of the added starch may react with other components of the binder to form reaction products that are different from any of the starting materials. The reacted starch products have a functionally similar role to the reacted cross-linking agent in forming a covalent bonded material. The unreacted starch present, if any, functions as an extender/filler that provides bulk to the binder which would otherwise be supplied by using more carboxyl-containing polymer and crosslinker.

The relative amount of starch to add can vary depending on other binder components used, the processing conditions, and the type of end product being made, among other considerations. Embodiments have the concentration of the starch (as a percentage weight of the binder composition) ranging from at least about 10%; at least about 20%; at least about 30%; at least about 40%; at least about 50%; etc. Additional ranges of the starch concentration may include about 10% to about 90%; about 20% to about 80%; about 20% to about 60%; about 20% to about 50%; about 30% to about 70%; etc.

The types of starches used may include native or modified, neutral or cationic, moderate to high molecular weight starches. The molecular weights of the starches may vary from about 10,000 g/mol or more; about 50,000 to 10,000,000; about 100,000 to about 10,000,000; about 100,000 to about 500,000; about 250,000 to about 500,000, etc. The native starch may be extracted from corn, potato, tapioca, and wheat, among other sources of starch. Commercially available examples of these starches may include RediBOND® from National Starch & Chemical, and starches from Hercules Incorporated, Avebe Group, and Emsland, Tate & Lyle, among other commercial suppliers.

The native starch may be converted into a cationic starch by adding a positively charged nitrogen group to the starch. For example, neutral starch may be reacted with an alkylammonium halide salt to replace one or more of the native hydroxyl groups on the starch with a positively charged, quaternary ammonium moiety. Examples of commercially available cationic starches include RediBOND® 5330 from National Starch & Chemical Co. of Bridgewater N.J.

The starches may be added to a variety of formaldehyde-free thermoset binder components. These may include carboxyl-containing polymers such as polycarboxylic acid binders that are prepared from one or more carboxylic acid monomers, such as acrylic acid, methacrylic acid, maleic acid, fumaric acid, crotonic acid, and itaconic acid, among other carboxylic acids. In addition (or in lieu of) the carboxylic acids, the binder may be prepared from one or more carboxylic acid anhydrides, such as acrylic anhydride, methacrylic anhydride, maleic anhydride, fumaric anhydride, crotonic anhydride, and itaconic anhydride. The polycarboxylic acid may be made from a single kind of carboxylic acid (i.e., a homopolymer), or may be made from two or more types of carboxylic acid (i.e., a copolymer).

The binder may also be made from copolymers of carboxylic acids (or acid anhydrides) with other types of monomers, such as vinyl compounds, aromatic compounds, etc. Examples of these monomers include styrene, α-methylstyrene, acrylonitrile, methacrylonitrile, methyl acrylate, ethyl acrylate, n-butyl methacrylate, isobutyl methacrylate, glycidyl methacrylate, vinyl methyl ether, and vinyl acetate, among others. The copolymers made from these monomer combinations may include styrene maleic anhydride (SMAn), styrene maleic acid, and styrene maleamic acids (SMAc), among other copolymers.

The size of the carboxyl-containing polymers (e.g., polycarboxylic acid polymers) may vary from about 100 g/mol to about 500,000 g/mol. For example, carboxyl-containing polymers may have a molecular weight from about 1000 to about 50,000 g/mol; about 1000 to about 10,000 g/mol; etc.

The binder may also include an hydroxyl and/or amino group containing cross-linking agent. For example, the cross-linking agent may include a polyol, such as a monomeric diol (e.g., ethylene glycol; 1,3-propanediol; 1,4-butanediol; and 1,6-hexanediol, etc.); a monomeric triol (e.g., glycerol, trimethylolalkanes including trimethylolethane and trimethylolpropane, and 1,2,4-butanetriol, etc.); an erythritol (e.g., 2-butene-1-erythritol, pentaerythritol, etc.), and/or a sorbitol, among other alcohols. The cross-linking agent may also include an amino alcohol such as trialcoholamine (e.g., trimethanolamine, triethanolamine (TEA), tripropanolamine, etc.).

The binder compositions may also include additional carboxylic acids and/or carboxylic acid anhydrides including dicarboxylic acids and anhydrides (e.g., maleic acid, maleic acid anhydride, phthalic acid, phthalic anhydride, tetrahydrophthalic acid, tetrahydrophthalic anhydride, etc.); tricaboxylic acids and anhydrides (e.g., citric acid; citric anhydride, etc.); tetracarboxylic acids and anhydrides (e.g., butane tetracarboxylic acid, etc.); aromatic carboxylic acids and anhydrides; mellitic acids and anhydrides (e.g., trimellitic acid, trimellitic anhydride, pyromellitic acid, pyromellitic anhydride, etc.); and rosins, among other carboxylic acids. These carboxylic acids may be present in the carboxyl-containing polymer, or separately added to a binder solution that may also include the carboxyl-containing polymer, cross-linking agent, starch, and (optionally) any additional binder components.

In some embodiments, a catalyst may aid in the curing of the binder. For example, a phosphorous-containing, sulfur-containing, metal-containing (e.g., Ti, Zr, Zn, Sn, etc.) catalyst, Lewis acid catalysis, etc., may optionally be added to cure the binder.

In some embodiments, a pH adjustment agent may also be added to increase the reaction rate for forming the binder. For example, sulfuric acid (H₂SO₄) may be added to the binder solution to reduce the pH to below 3.0. The lower pH increases the reaction rate of the binder components, reducing the time needed to form the final binder composition.

The components of the binder may be mixed together in an aqueous solution. For example, a carboxyl-containing polymer, cross-linking agent, curing catalyst, starch and water may be mixed together to make the aqueous binder solution. The relative ratios of the components in the aqueous solution may vary widely. For example, the ratio of cross-linking agent to carboxyl-containing polymer, characterized by the molar ratio of hydroxyl groups in cross-linking agent to carboxyl groups in carboxyl-containing polymer, may vary from about 0.5 to about 2.5 (e.g., a crosslinker:carboxyl-containing polymer ratio of about 0.5 to about 1.0).

Water may be added to the binder components, or the binder components may be added (individually or as a mixture) to an amount of pure water. The water may be the largest single component of the aqueous binder solution, and the percentage of water in the solution may depend on the viscosity, flow rate, and/or other solution properties desired.

The aqueous binder compositions may be applied to mineral and/or polymer fibers to form a fiber product, such as insulation batt, and woven and non-woven mat, among other products. The fibers may include glass and/or polymer fibers having a length from about 0.25 inches to about 3 inches (e.g., about 0.5 to about 1.5 inches) and a diameter from about 1 μm to about 30 μm (e.g., about 3 μm to about 6 μm). The aqueous binder compositions may be applied to the fibers by spraying or immersion, among other application techniques. The binder mixed with the fibers may then be dried and cured in an oven. The curing process may involve placing the binder and fiber mixture into a curing oven where heated air passes over and/or through the fiber product. Temperatures in the curing oven may range from about 100° C. to about 325° C. during the curing operation, which may last for about 30 seconds to about 3 minutes.

### Experimental

Tensile strength tests were performed on various binder compositions before and after being aged in simulated hot and humid conditions. The strength tests showed that binder compositions formulated according to embodiments of the invention had improved tensile strength compared with conventional binder compositions that lacked moderate to high molecular weight starches. The tests also demonstrated that the present compositions were more resistant to deleterious aging in hot and humid conditions than conventional formaldehyde-free binders and low molecular weight starch containing binders.

### Experiment #1: Handsheet Evaluations of Starches in Binder Formulations

A commercial polyacrylic acid binder (QRPX-1692 binder from Rohm & Haas Company) was combined with two starches of different molecular weights: (1) StarDri-100 (a low molecular weight (<10,000 g/mol) maltodextrin from Tate & Lyle, and (2) RediBOND 5440 (a high molecular weight (˜1,000,000 g/mol) cationic starch from National Starch and Chemical Company. The binder (QRXP-1962 binder from Rohm & Haas Company) is similar to binders described in U.S. Pat. No. 5,661,213 to Arkens et al., and U.S. Pat. No. 6.071,994 to Hummerich et al, the entire contents of both patents being herein incorporated by reference for all purposes. Also added to the combination was a polyol cross-linking agent (triethanolamine), a phosphorous-containing catalyst. In addition, a silane coupling agent ((3-glycidoxypropyl)methyldiethoxysilane) made up about 1%, by wt., of the combined mixture to enhance the binding between the fibers and the binder.

The pH of the binder composition is adjusted to 2.8. Then, glass microfiber filter paper sheets (20.3×25.4 cm, Cat No. 1820 866, Whatman International Ltd., Maidstone, England) are coated with the binder composition via dip coating to achieve a LOI (loss on ignition) of 7%. The coated sheets are then dried and cured at 204° C. for 3 minutes in a Mathis oven.

A handsheet evaluation was conducted on the binders both before and after they were aged under hot and humid conditions. The aging process involved exposing a fiberglass mat containing the cured binder to air at a temperature of 120° F., with 95% relative humidity for 5 days. The handsheet evaluations involved taking the mat pieces before and after aging and cutting them into 1 inch×4 inch pieces for tensile testing to obtain a peak load. Table 1 shows the results of the evaluations for the binder compositions:

TABLE 1
Peak Load results for QRXP-1692 Binder Compositions
Having Various Starches

| | Peak load (lbf) | | |
|---|---|---|---|
| Composition | | Humid | Humid Aging |
| (% wt.) | Unaged | Aged | Retention |
| QRXP-1692 Binder (“1692”) (100%) | 6.83 | 5.34 | 78.2% |
| 1692 (70%) + RediBOND5330 | 7.17 | 6.15 | 85.8% |
| (30%) | | | |
| 1692 (70%) + StarDri100 (30%) | 6.44 | 5.04 | 78.3% |

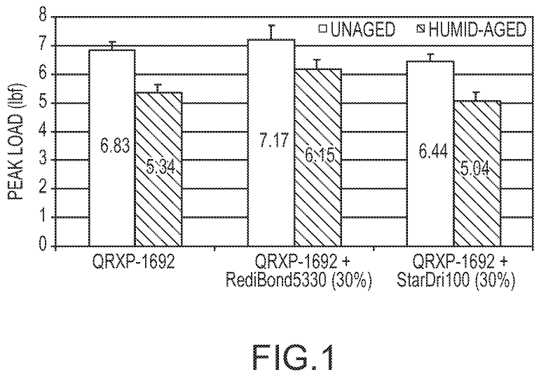

FIG. 1 plots the results for the handsheet evaluations tabulated in Table 1 for various types of starches. It also plots the result of a comparative test that only used the conventional polyacrylic acid binder without starch. The results for unaged binder show that the conventional binder without starch could withstand a higher peak load than binders adding 30% by wt. of the dextrin starches (StarDri100). However, the peak loads for unaged binders having both the 30%, by wt., high molecular weight starch (RediBOND5330) was higher than that of the polyacrylic acid binder alone.

The handsheet evaluations also showed that binder compositions having the high molecular weight cationic starch had less deterioration after exposure to the humid aged conditions. The peak load of the binder-containing high molecular weight starch (i.e., RediBOND5330) is substantially higher than those of ORXP-1602 alone, and the binder containing low molecular weight dextrin starch (StarDri100). This result is unexpected if the starch is merely acting as an unreacted extender that displaces some of the more costly polyacrylic acid binder. Instead, the increased resiliency of the binder is indicative of the starch chemically reacting with other binder components to form a final binder composition with improved properties over the conventional binder alone. Thus, not only does the high molecular weight starch component reduce costs, it also improves the durability and lifetime of fiber products made with the binder.

### Experiment #2: Tensile Strength Tests for Another Polyacrylic Binder and Starch

Another polyacrylic acid binder (QRXP-1740 from Rohm & Haas Company) was combined varying concentrations of a high molecular weight cationic starch (RediBOND5330). The QRXP-1740 binder composition includes a polyacrylic acid, a low molecular weight polyacid, a polyol cross-linker, and a phosphorous-containing catalyst. In addition, a silane coupling agent, (3-glycidoxypropyl)methyldiethoxysilane, was added to the binder at about 1.6% weight. The pH of the binder composition was adjusted to 2.8. The binder composition and glass beads were mixed together, and then pressed into molds of a “dogbone” shape to form test samples. The molded samples were then dried and cured in an oven at 200° C. for 20 minutes. The LOI of the dog bone samples is 2.4%.

Dogbone tensile tests were conducted on the binders both before and after they were aged under hot and humid conditions. The aging process involved exposing the dogbone samples containing the cured binder to air at a temperature of 120° F., with 95% relative humidity for 24 hours. Table 2 shows the results of the evaluations for the binder compositions:

TABLE 2
Tensile Strength Tests for QRXP-1740 Binder Compositions
Containing Various Concentrations of High Molecular Weight
Starch (RediBOND5330)

| | |
|---|---|
| | Tensile Strength |
| Composition | (MPa) |

| (% wt.) | Unaged | Humid-aged |
|---|---|---|
| QRXP-1740 (100%) | 2.80 | 1.80 |
| QRXP-1740 (90%) + RediBOND5330 | 2.57 | 1.93 |
| (10%) | | |
| QRXP-1740 (80%) + RediBOND5330 | 3.02 | 1.96 |
| (20%) | | |
| QRXP-1740 (70%) + RediBOND5330 | 3.18 | 2.42 |
| (30%) | | |

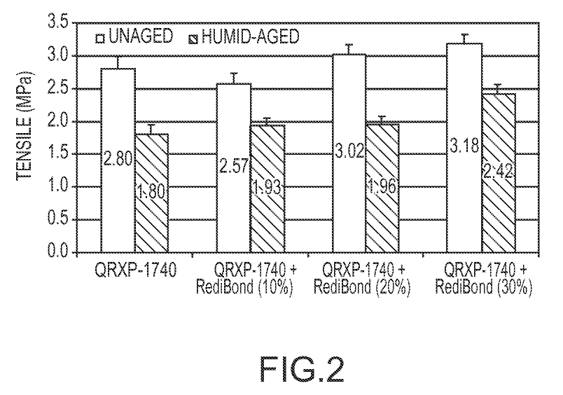

FIG. 2 plots the results for the Dogbone tensile tests tabulated in Table 2 for 0%, 10%, 20%, and 30%, by wt., concentrations of a high molecular weight starch (RediBOND5330). The results show that increasing the starch concentration from 10% to 30%, by wt., improves the tensile strength of the binder under both unaged and humid aged conditions. In addition, when the starch concentration in the binder reaches 30%, the tensile strength of the binder is substantially increased compared with the QRXP-1740 binder that lacks starch.

### Experiment #3: Tensile Strength Tests for SMAc Binder and Starch

A carboxyl-containing synthetic binder, made from copolymers of styrene maleamic acid (SMAc) mixed with a triethanolamine (TEA) cross-linker, was combined with a high molecular weight cationic starch (RediBOND5330). Additional details on the formation of the SMAc may be found in U.S. patent application Ser. No. 11/799,904 filed May 3, 2007 and titled “Binding of Fibrous Material Utilizing a Crosslinked Polyamic Acid,” the entire contents of which is herein incorporated by reference for all purposes. In addition 0.8%, by wt., of aminopropylsilane was added to the binder as a coupling agent between the resin and glass.

More Dogbone tensile tests were conducted on the binders both before and after they were aged under hot and humid conditions. The aging process involved exposing a dogbone sample containing the cured binder to air at a temperature of 120° F., with 95% relative humidity for 24 hours. Table 3 shows the results of the evaluations for the binder compositions:

TABLE 3
Tensile Strength results for SMAc Binder Compositions:

| | |
|---|---|
| | Tensile Strength |
| Composition | (MPa) |

| (% wt.) | Unaged | Humid Aged |
|---|---|---|
| SMAc/TEA Binder | 2.4 | 2.1 |
| SMAc + RediBOND5330 (10%) | 3.1 | 2.4 |
| SMAc + RediBOND5330 (20%) | 2.8 | 2.8 |
| SMAc + RediBOND5330 (30%) | 2.6 | 2.8 |
| SMAc + RediBOND5330 (40%) | 2.7 | 2.7 |
| SMAc + RediBOND5330 (50%) | 2.2 | 2.3 |

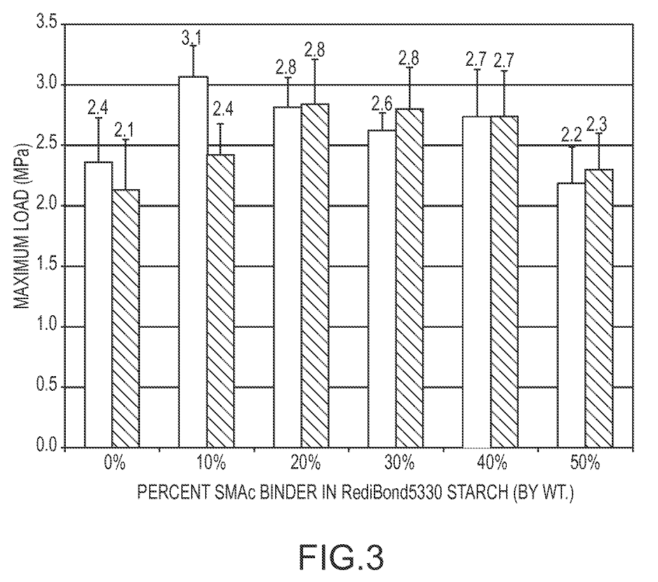

FIG. 3 plots the results for the Dogbone tensile tests tabulated in Table 3 for 0%, 10%, 20%, 30%, 40% and 50%, by wt., concentrations of the high molecular weight starch (RediBOND5330). Similar to the results for the polyacrylic acid binders, the results show that adding the starch to carboxyl-containing synthetic binders such as SMAc improves tensile strength compared to formulations of the binder without the starch. In addition, as the starch concentration increased to 20% wt or more, the loss of tensile strength binder exposed to humid aged conditions was substantially mitigated. Thus the improvements seen by adding high molecular weight starches to conventional, formaldehyde free binder compositions apply to a wide rage of polycarboxylic acid binders, including polyacrylic acid, and copolymers of carboxylic acid (or carboxylic acid anhydrides) with vinyl compounds (e.g., SMAc and SMAn).

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the electrode” includes reference to one or more electrodes and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A binder composition comprising:
a carboxyl-containing polymer;
a cross-linking agent; and
a starch with a molecular weight greater than 10,000 g/mol.

2. The binder composition of claim 1, wherein the starch has a molecular weight between 10,000 g/mol and about 10,000,000 g/mol.

3. The binder composition of claim 1, wherein the starch comprises a cationic starch.

4. The binder composition of claim 1, wherein the starch comprises at least about 5%, by wt., of the binder composition.

5. The binder composition of claim 1, wherein the starch comprises from about 5% to about 60%, by wt., of the binder composition.

6. The binder composition of claim 1, wherein the carboxyl-containing polymer comprises a monomer unit prepared from a carboxylic acid selected from the group consisting of acrylic acid, methacrylic acid, maleic acid, fumaric acid, crotonic acid, and itaconic acid.

7. The binder composition of claim 1, wherein the carboxyl-containing polymer comprises a monomer unit prepared from a carboxylic acid anhydride selected from the group consisting of acrylic anhydride, methacrylic anhydride, maleic anhydride, crotonic anhydride, and itaconic anhydride.

8. The binder composition of claim 1, wherein the carboxyl-containing polymer comprises a copolymer prepared from a carboxylic acid or carboxylic acid anhydride, and a vinyl compound.

9. The binder composition of claim 8, wherein the vinyl compound is selected from the group consisting of styrene, α-methylstyrene, acrylonitrile, methacrylonitrile, methyl acrylate, ethyl acrylate, n-butyl methacrylate, isobutyl methacrylate, glycidyl methacrylate, vinyl methyl ether, and vinyl acetate.

10. The binder composition of claim 8, wherein the carboxyl-containing polymer comprises styrene maleic anhydride, styrene maleic acid, or styrene maleamic acid.

11. The binder composition of claim 1, wherein the cross-linking agent comprises a polyol.

12. The binder composition of claim 11, wherein the cross-linking agent comprises an amino alcohol.

13. The binder composition of claim 11, wherein the amino alcohol comprises triethanolamine.

14. The binder composition of claim 1, wherein the binder further comprises a carboxylic acid or carboxylic acid anhydride selected from the group consisting of citric acid, rosins, maleic acid, maleic anhydride, phthalic acid, phthalic anhydride, butane tetracarboxylic acid, trimellitic acid, trimellitic anhydride, pyromellitic acid, pyromellitic anhydride, tetrahydrophthalic acid, and tetrahydrophthalic anhydride.

15. The binder composition of claim 1, wherein the binder composition further comprises a pH adjustment agent.

16. The binder composition of claim 1, wherein the pH adjustment agent comprises sulfuric acid.

17. The binder composition of claim 1, wherein the binder composition further comprises a curing catalyst.

18. A binder composition comprising:
a carboxyl-containing polymer;
an amino alcohol crosslinking agent; and
a starch.

19. The binder composition of claim 18, wherein the starch comprises a cationic starch having a molecular weight greater than 10,000 g/mol.

20. A fiber product comprising:
mineral or polymeric fibers and a binder prepared from an aqueous composition comprising
a carboxyl-containing polymer;
a cross-linking agent; and
a starch with a molecular weight greater than 10,000 g/mol.

21. The fiber product of claim 20, wherein the mineral or polymeric fibers comprise glass fibers.

22. The fiber product of claim 20, wherein the starch comprises a cationic starch.

23. The fiber product of claim 20, wherein the fiber product is selected from the group consisting of an insulation batt, a woven fiberglass mat, a non-woven fiberglass mat, and a spunbond product.
